(19) United States
(12) Patent Application Publication
(10) Pub. No.: US 2002/0103669 A1
(43) Pub. Date: Aug. 1, 2002

(54) Methods and systems for coordinating the flow of data

(76) Inventors: Thomas W. Sullivan SR., Tucson, AZ (US); Thomas Sullivan JR., Tucson, AZ (US); Joshua Oster-Morris, Tucson, AZ (US)

Correspondence Address: MILLER NASH LLP, 4400 TWO UNION SQUARE, 601 UNION STREET, SEATTLE, WA, 98101-2352, US

(21) Appl. No.: 10/060,110

(22) Filed: Jan. 29, 2002

Related U.S. Application Data
(60) Provisional application No. 60/265,150, filed on Jan. 29, 2001.

(51) Int. Cl. G06F 17/60

(52) U.S. Cl. 705/1

(57) ABSTRACT

A system for coordinating the flow of data relating to at least one real estate transaction between parties associated with the real estate transaction, the system having a centralized transaction coordination system for accessing a transaction database and at least one interface device for accessing the transaction coordination system, each interface device associated with a party to the real estate transaction. Information relevant to the real estate transaction is provided directly to the transaction coordination system by at least one information originating party originating the information, and the information is stored in the transaction database. Access to the information is provided to at least one party to the real estate transaction using the at least one interface device to access the transaction coordination system.

The present application is based on, and claims priority from, provisional application serial No. 60/265,150, filed Jan. 29, 2001, and is hereby incorporated herein by reference.

### BACKGROUND OF INVENTION

1. Field of Invention

The present invention relates to novel, improved methods, apparatus, and systems for managing the flow of data in real estate transactions.

2. Background

There are numerous types of real estate transactions including, but not limited to residential property sales, resale of residential property (e.g. existing single-family residential property owner title transfers), commercial real estate sales (e.g. industrial, land, and multi-family housing), new home construction sales (e.g. custom home building, subdivision production, and manufactured housing), trustee sales (e.g. sales occurring due to the foreclosure of a property), second loan situations (e.g. those situations in which there is a “Home Equity Loan” that takes second position or lower as enforceable liens on a property), refinancing of an existing loan on a property, and any other sale, transfer, or financial transaction involving real property. All of these real estate transactions involve paperwork.

The real estate industry has historically been known for the enormous amount of paperwork generated in a real estate transaction. In today's litigious society, the quantity of documentation involved in a real estate transaction has increased. The quality of the documentation must be pristine. The added quantity and quality documentation burdens have redefined the role of the real estate broker and real estate agent.

The added quantity and quality documentation burdens have also redefined traditional relationships in real estate. The real estate broker, faced with having to maintain pristine files, puts increased pressure on the real estate agent to do so as well. The real estate agent, forced to focus on processing paperwork, is distracted from focusing on the client.

Currently, the real estate agent is the coordinator of a real estate transaction in which many “vendors” play a role before the real estate transaction has been completed. These vendors may include, for example, escrow companies, title companies, lending institutions, escrow agents, warranty providers, appraisers, inspectors (e.g. home inspectors, pest inspectors), insurance companies, appraisers, utility providers, survey companies, government entities, builders, engineers, material providers, attorneys, and other service providers and their agents and staff. It is a responsibility of the real estate agent to monitor all of the vendors in a real estate transaction and gather all of the information required for the file. An error or omission in monitoring by the real estate agent may result in an unsuccessful closing, future litigation, higher insurance rates, and/or unhappy clients. Monitoring is a large task that requires many phone calls and appointments and much busy work. The increase in the geographical areas that today's real estate agents cover has increased the difficulty of monitoring since a real estate agent may deal with a client or a vendor that is out-of-state or even in a different country.

Vendors and real estate agents rely on each other to supply required information. If there is a delay or error in the transmission of the required information, it can be detrimental to the real estate transaction. Participants in a real estate transaction may not be available at all times to answer questions, and this is a problem. Also, the documentation of verbal conversations is hard to accomplish, and paper can be misplaced or denied all too easily.

It has become virtually impossible for real estate professionals to handle a real estate transaction and the paperwork it generates manually. Consequently, there is a continuing need for a better way of managing the flow of information among the several parties involved in a real estate transaction.

U.S. Pat. No. 6,321,202 B1 (the “'202 patent”) and U.S. patent application Publication US2001/0047282 A1 (the “'282 publication”), both to Raveis, Jr., are directed to systems and methods for managing real estate transactions relating to real estate. Both of these references disclose systems limited to particular purposes.

The '202 patent, for example, is directed to a method of receiving and storing data related to a plurality of contacts including buyers and sellers of real estate, receiving and storing data relating to a plurality of vendors each associated with at least one phase of a real estate transaction, accessing vendor data based upon the occurrence of a particular phase of the real estate transaction and communicating data relating to the vendors to a contact upon occurrence of the particular phase of the real estate transaction. The system, however, is limited in that it is meant to be accessible only to real estate personnel (e.g. sales, management, and administrative personnel) and “contacts” (e.g. buyers and sellers). Vendors' information is input into the system for purposes of cross-selling products and services. The vendors, however, are not given access to the system. This limits the value of the system because real estate personnel or contacts must enter the vendors' information which most likely delays entry of relevant information. Further, vendors cannot take advantage of the system because they are denied access to it.

The '282 publication is directed to a system for managing real estate transactions including gathering, utilizing, disseminating, and controlling information relating to real estate transactions. The value of cross-selling goods and services is also discussed in this publication. This publication, however, is primarily focused on a system that monitors the relational and economic aspects of a real estate transaction.

### BRIEF SUMMARY OF THE INVENTION

The present invention is directed to a novel and improved transaction coordination system for directing the flow of the information appurtenant to a real estate transaction. Specifically, the present invention is directed to a transaction coordination system for coordinating and facilitating activities and procedures involved in a real estate transaction, before, during, and after the real estate transaction. The transaction coordination system provides online, real time, interactive communication and coordination between all parties to the real estate transaction through a central hub that has a transaction coordinator. In one preferred embodiment, the transaction coordination system uses generic or popular software, has an open architecture, and is modular for optimum efficiency and versatility.

The present invention is directed to a system for coordinating the flow of data relating to at least one real estate transaction between parties associated with the real estate transaction. The system is comprised of a centralized transaction coordination system for accessing a transaction database and at least one interface device for accessing the transaction coordination system, each interface device associated with a party to the real estate transaction. Information relevant to the real estate transaction is provided directly to the transaction coordination system by at least one information originating party originating the information, and the information is stored in the transaction database. Access to the information is provided to at least one party to the real estate transaction using the at least one interface device to access the transaction coordination system.

In one preferred embodiment, information relevant to at least one real estate transaction is monitored by a transaction coordinator. In a separate preferred embodiment, a login screen is provided, through which each party to the real estate transaction accesses the transaction coordination information by entering login information. Each party to the real estate transaction has an associated customized access level determinable by the login information entered by each party. Each party to the real estate transaction has an associated customized access screen determinable by the customized access level, each party to the real estate transaction being provided access only to information associated with real estate transactions to which the party is associated.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is an exemplary schematic diagram of the flow of information between the parties to a real estate transaction in an information management system using the principles of the present invention.

FIG. 2 is an exemplary schematic diagram of a transaction coordination system for routing information in accord with the principles of the present invention.

FIG. 3 is an exemplary block diagram of how information can be accessed by an authorized party accessing the transaction coordination system of the present invention using a personal digital assistant (PDA) or other wireless device.

FIG. 4 is an exemplary block diagram of representative information that can be accessed by a real estate agent accessing the transaction coordination system of the present invention.

FIG. 5 is an exemplary block diagram of representative information that can be accessed by a real estate agent's broker accessing the transaction coordination system of the present invention.

FIG. 6 is an exemplary block diagram of representative information that can be accessed by a vendor accessing the transaction coordination system of the present invention.

FIG. 7 is an exemplary block diagram of representative information that can be accessed by a consumer accessing the transaction coordination system of the present invention.

FIGS. 8A-8B are an exemplary block diagram of representative information that can be accessed by a system coordinator accessing the transaction coordination system of the present invention.

FIG. 9 is a block diagram showing representative information that can be accessed by a system administrator accessing the transaction coordination system of the present invention.

### DETAILED DESCRIPTION OF THE INVENTION

The present invention relates to novel systems for “online” “real time” management of the flow of information between parties to almost any type real estate transaction. Exemplary parties that may use the present invention include, but are not limited to buyers, sellers, real estate agents, real estate brokers, real estate agent support staff, escrow company, title company, lending institution, attorneys, government entities, engineers, and any of the vendors set forth in this specification. The specific parties set forth in this specification are meant to be exemplary and are not intended to limit the types of parties with which systems of the present invention may be used. Similarly, the specific real estate transactions set forth in this specification are meant to be exemplary, and are not meant to limit the types of real estate transactions with which the systems of the present invention may be used.

Central to the present invention is the use of a transaction coordinator 100. The transaction coordinator 100 is a designated person who has access to the networked transaction coordination system 200 that has access to the entire transaction database 210a-b. The transaction coordinator 100 may be any designated person including, but not limited to a real estate agent, a broker's employee, an escrow officer, a third party provider, or an assistant. In one preferred embodiment, the transaction database 210a-b is only accessible through the networked transaction coordination system 200. One advantage of using a transaction coordinator 100 is that he can monitor many real estate transactions at the same time.

The present invention can reduce or eliminate the need for an assistant to the agent or broker by mechanizing many of the projects and duties traditionally performed by an assistant, relieve the assistant from having to perform certain projects and duties, or improve the efficiency of the assistant if the assistant is trained as the transaction coordinator 100. For example, in one preferred embodiment, the present invention significantly decreases the time and effort involved in researching a properties or developing marketing materials. The transaction coordinator 100 can research individual properties or prepare lists of properties within a desired school district, having specific amenities or utilities, having desired CC&R's (“covenants, conditions, and restrictions”), belonging to particular Home Owner Associations, or having any combination of these features. The transaction coordinator 100 can develop marketing materials by creating listing books, marketing flyers, and other written material. Another duty the present invention may facilitate is the facilitation of post-transaction (or post-closing) relationships with clients or other parties. For example, by sending appropriate greetings for holidays, birthdays, and anniversaries or by sending information on changes in the law, or properties in which the client might be interested, or comparative market analyses to promote the resale of the property, the real estate agent is able to provide valuable client contact that can lead to future business. Performing post-transaction activities can be a valuable source of further business and/or referrals, but often agents (or harried assistants) are too busy to perform them. Reducing or eliminating the need for an assistant or making the assistant more efficient is significant because assistants require expensive training that, because of the high turnover rates, is often repeated. Assistants also must be paid whether or not an agent or broker is productive.

Also central to the present invention is that the networked transaction coordination system 200 is a networked system in which parties are networked to the transaction coordinator 100. In one preferred embodiment, the transaction coordination system 200 is networked through the internet. An online communication system gives all parties involved the ability to accurately communicate on a specific real estate transaction, 24 hours a day, 7 days a week, 365 days a year. The parties may communicate by e-mail, by posting to a central transaction database 210a-b, fax, wireless device, and any other network communication method. This also allows for all of the parties involved in a real estate transaction to be linked together at a single virtual location.

Use of a centralized transaction database 210a-b is another important concept of the present invention. For example, use of a centralized transaction database 210a-b reduces or eliminates the need for physical storage of paperwork since all documents can be scanned into electronic files that are accessible by the transaction coordination system 200. Documents not requiring an original signature can be completely disposed of after it is scanned into the transaction coordination system 200. Documents in which the original signature might be necessary in future litigation or business dealings would need to be retained. By creating a paperless real estate transaction, all pertinent documents are instantly retrievable by parties having appropriate security clearances. Security features allow various levels of user access to parties to the real estate transaction. The security features also protect the integrity of the transaction database 210a-b.

Another central feature of the present invention is that real estate transactions may be entered and monitored online and in real time by all of the relevant parties. The online real time tracking occurs through the use of an automated timeline and report generation system. The automated timeline and report generation system shows all tasks that need to be dealt with on a specific day or specific days in the future, highlighting on priority. Online real time tracking allows all necessary parties to view the progress of the real estate transaction and follow critical dates for each party's respective obligations. Vendor interfaces to the transaction coordination system 200 generate real time real estate transaction timeline updates. Because information is entered directly by the relevant party and in real time, errors generally caused by oral or written repetition of information are eliminated, confusion is reduced, and accuracy is promoted.

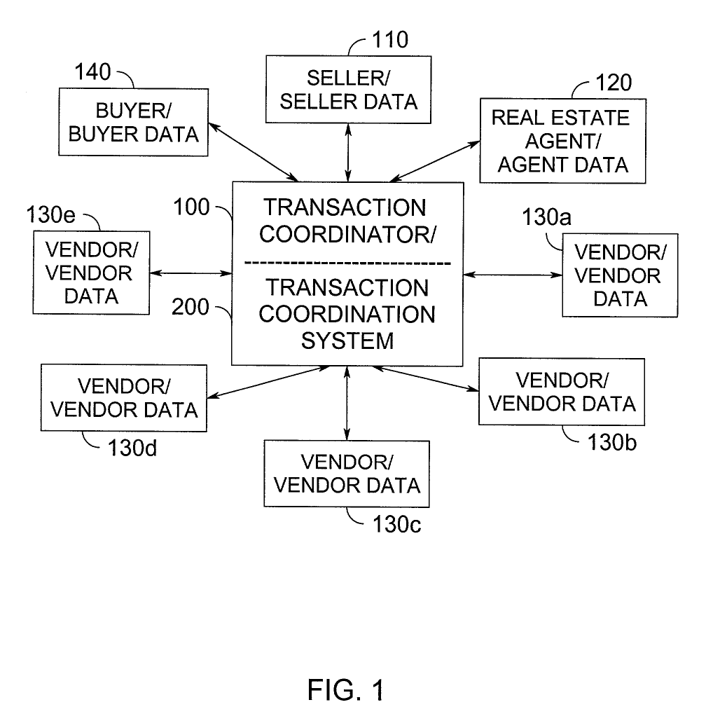

FIG. 1 shows an exemplary embodiment of the present invention that promotes efficiency and reduces the cost of a real estate transaction by providing for an interactive transaction coordination system 200 that connects all of the parties to a real estate transaction through a central hub. The central hub, the transaction coordinator 100, allows for the routing of data from the real estate transaction parties 110, 120, 130a-e, 140 to a transaction coordinator 100 and distributing information from the transaction coordinator 100 to the transaction parties 110, 120, 130a-e, 140.

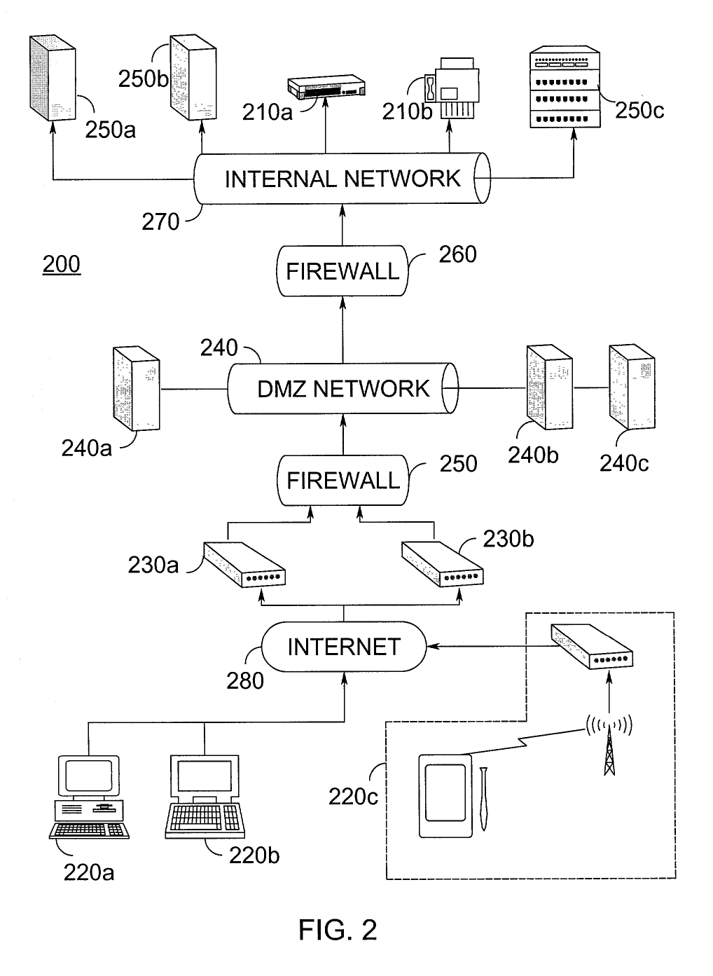

FIG. 2 details an exemplary, representative networked transaction coordination system 200 for routing information stored in a transaction database 210a-b between parties of a real estate transaction who access the transaction coordination system 200 through traditional and nontraditional interface devices 220a-c. Specifically, redundant Internet connections 230a-b allow parties to use web servers 240a-c with a high likelihood of success. The redundant connections also provide fail over protection. In one preferred embodiment, a first firewall 250 provides security by limiting Internet traffic to only allow TCP/IP ports and addresses. The redundant array of web servers 240a-c offers a high availability to the transaction coordination system 200 resources and a low likelihood of total failure of the transaction coordination system 200. In one preferred embodiment, all connections with the web servers 240a-c are encrypted using a standard SSL (secure socket layer) encryption system. The web servers 240a-c communicate with redundant database servers 250a-b and other internal network devices through a second firewall 260 to add the highest level of security for customer transaction data stored in a transaction database 210a-b. This “internal network” 270 cannot be accessed directly from the Internet 280. The internal network 270 has multiple redundancies including, but not limited to, RAID protection for both the primary database servers 250a-b and the imaging servers 250c. The secondary database server 250b, a mirror of the primary server 250a, keeps the transaction coordination system 200 running if the primary server 250a fails. Further, all vital data is backed up to tape 210a daily and taken off-site on a weekly basis for catastrophic failure protection. Parties can connect to the transaction coordination system 200 directly over the Internet 280 using broadband or dial-up connections through ISPs. In addition, parties can view data and reports via digital PCS (cell phone technology) with a PDA (personal digital assistant like the Palmg series from Palm, Inc. of Santa Clara, Calif.) 220c.

One advantage of using a thin client model such as that shown in the transaction coordination system 200 of FIG. 2, is that it uses standard technologies with high levels of public distribution and acceptance and supports standard Internet browsers (e.g., Microsoft Internet Explorer® (manufactured by Microsoft Corporation of Redmond, Wash.) and Netscape Communicator® (manufactured by Netscape Communications Corporation of California)) and e-mail programs. The thin client model also allows for the highest levels of distribution (anyone with a computer and access to the Internet can reach the login screen 300) with very low per desktop cost for the interface device's 220a-c owner.

The representative networked transaction coordination system 200 set forth above has several additional advantages. For example, the per desktop costs are low because there is no packaging, shipping, disk duplication, or printing costs for shipping special software to parties of a real estate transaction or other potential users. Further, as changes to the transaction coordination system 200 software are made, “service packs” or update disks, do not need to be shipped. Another advantage is that as the user base grows only the infrastructure of the transaction coordination system 200 needs to be expanded. Expansion, therefore, would lower per desktop costs further as a result of bulk discounts on bandwidth, and other associated charges. Yet another advantage of the transaction coordination system 200 of the present invention is that it creates a high level of performance and redundancy for all parties. Despite the advantages of the networking method described herein, other networking methods could be used to implement the present invention.

It should be noted that the transaction coordination system 200 set forth herein is meant to be exemplary and can be modified for its intended purpose or to take advantage of new technologies. For example, other interface devices 220a-c may be used to access the transaction coordination system 200, the transaction database 210a-b may be stored on other types of technology, other means of security may be substituted for the firewalls 250, 260, and the redundancy may be increased or eliminated.

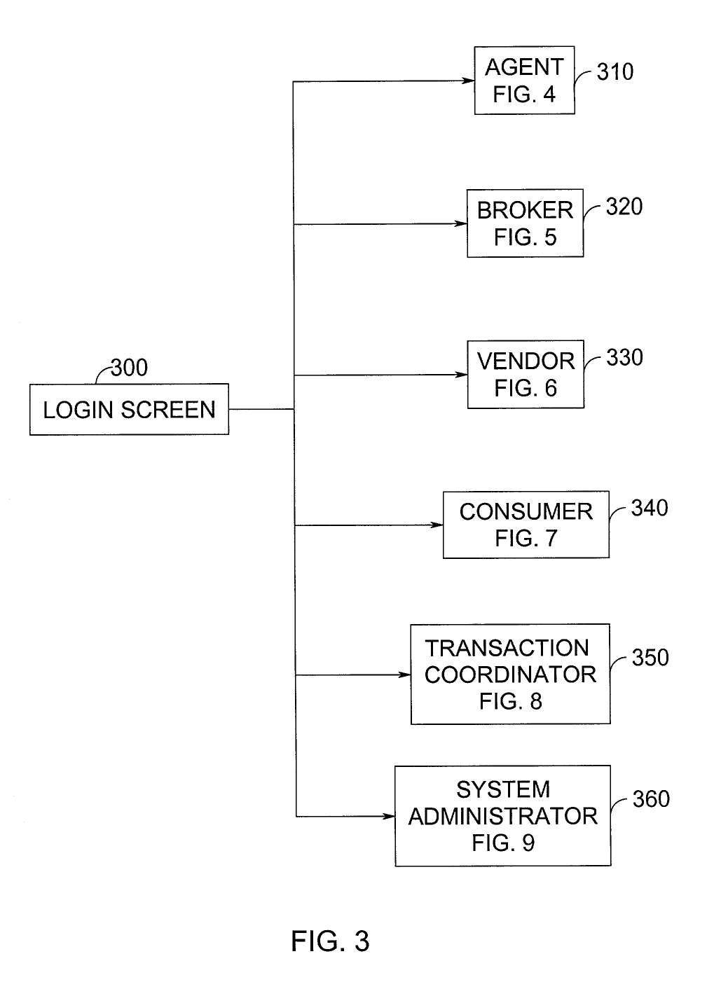

FIG. 3 shows how the present invention is configured to allow any party to a real estate transaction can access the transaction coordination system 200 from a single login screen 300 to access information on a real estate transaction in which the parties are involved using an interface device 220a-c. Each party, after entering his appropriate user name and password (or other security measures are taken), is connected an appropriate screen in which he may access portions of the transaction coordination system 200 to which he has clearance. FIG. 3 shows exemplary parties that may access the transaction coordination system 200 and the figure that details their respective exemplary portions of the transaction system 200. Specifically, FIG. 3 shows exemplary parties including a real estate agent 310, a real estate broker 320, a vendor 330, a consumer 340, a transaction coordinator 350, and a system administrator 360.

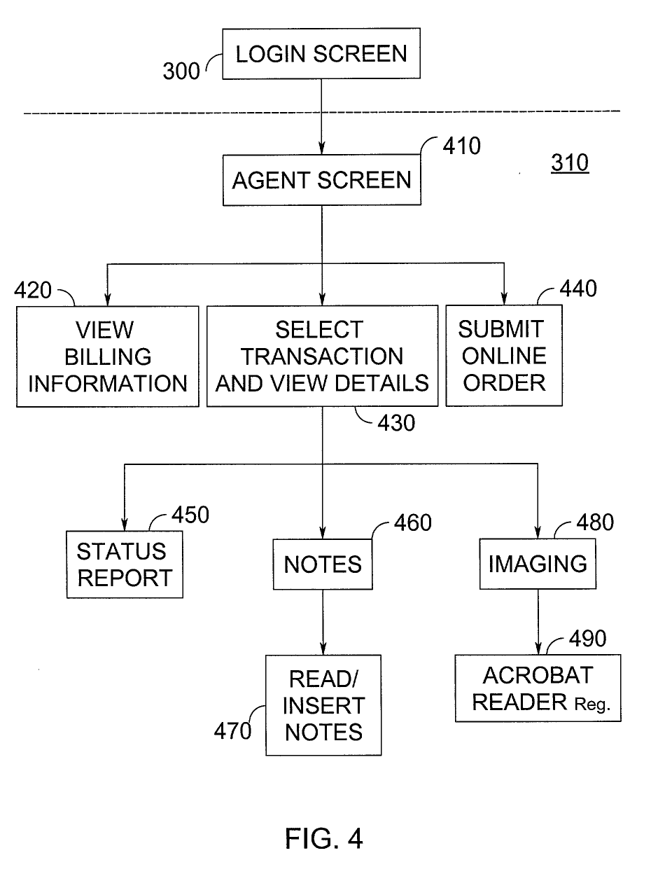

As mentioned, each party must enter his appropriate login information (e.g. user name, password) or otherwise activate a secure connection. Once the party's identification has been established, he may be connected to an appropriate screen from which he may access portions of the transaction coordination system 200 to which he has clearance. If the party enters a user name and password, the transaction coordination system 200 scans the transaction database 210a-b to determine whether the party has clearance to enter the transaction coordination system 200 and what level of clearance he should be given. The user is then connected to the appropriate party interface screens (FIGS. 4-9) based on their access level. If the user is not found in the transaction database 210a-b, an error occurs and the user is not allowed to access the transaction database 210a-b. In one preferred embodiment, a user who is denied access is given the option of establishing an account, given information on how to contact the appropriate person so that an account may be established, or is given access to a very limited subsystem established for “guests.”

FIG. 4 shows an exemplary means by which a real estate agent can access the present invention. After entering the appropriate information at the login screen 300, the user would be identified as a real estate agent and be sent to an appropriate agent screen 410. In a preferred embodiment the agent screen 410 is specifically linked to the agent's specific real estate transactions. In one preferred embodiment when the real estate agent accesses the appropriate agent screen 410, he is given a list of all of his real estate transactions. The real estate agent may be alerted and advised of any unread messages or upcoming calendared events.

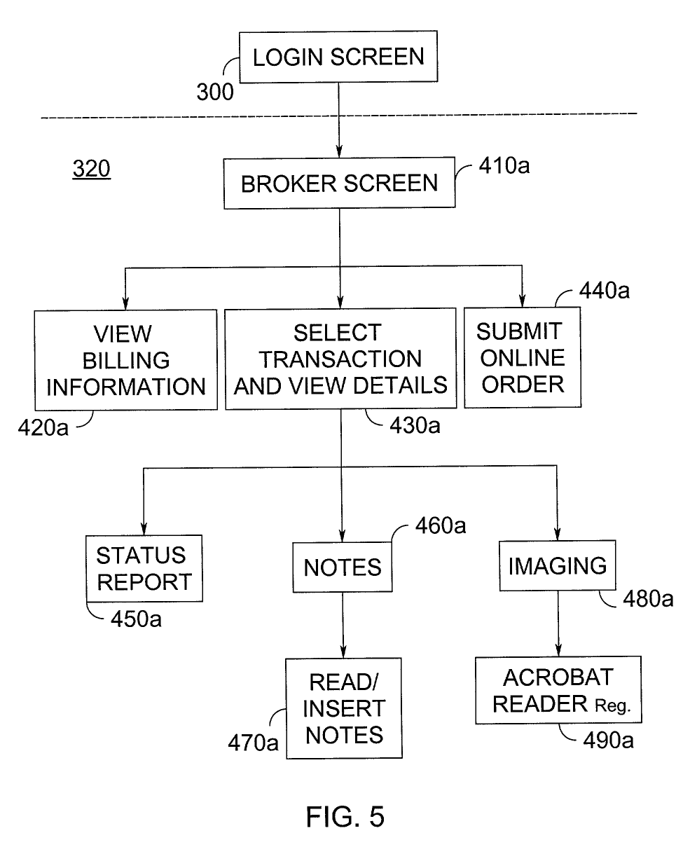

FIG. 5 shows an exemplary means by which a real estate broker can access the present invention. After entering the appropriate information at the login screen 300, the user would be identified as a broker and be sent to an appropriate broker screen 410a. In a preferred embodiment the broker screen 410a is specifically linked to the broker's specific real estate transactions. As real estate brokers often work with multiple real estate agents, the transaction coordination system 200 may be configured such that the broker has access to all of the information for all of the transactions of the agents with whom he works. When the real estate broker accesses the appropriate real estate broker screen 410a, he may receive a list of each of his real estate branches and a list of his real estate agents, including all of the real estate agents' real estate transactions that are under the real estate broker's control. The broker may review all the transactions under a single broker's screen or by accessing the transactions divided into subcategories by real estate agent, location, or any other subcategory or combination of subcategories.

For each transaction, a real estate agent or broker may view billing information 420, 420a, select transaction and view details of the transaction 430, 430a, submit orders online 440, 440a, obtain a status report for one or more transactions 450, 450a, take notes 460, 460a, read or insert notes 470, 470a, and perform imaging 480, 480a using an imaging program 490, 490a. More specifically, billing information 420, 420a may include showing the real estate agent or broker a list of invoice items and brief descriptions of charges. Performing online intake orders 440, 440a allows the real estate agent or real estate broker to enter data for a new real estate transaction. The data entered by the real estate agent or real estate broker may be subsequently forwarded to the transaction coordinator 100 or to a system administrator (who oversees the one or multiple transaction coordination systems 200) who, in turn, generates a new real estate transaction based on the online intake form. The use of the online intake order form prevents the double keying of data, a process that wastes the valuable time and tends to increase errors. Real estate transaction details 430, 430a may include general information concerning the real estate transaction itself, status reports 450, 450a, notes 460, 460a, and imaging 480, 480a. The status report 450, 450a may display a report on the timeline of the particular real estate transaction, may list all notes of all the parties, and may include homework information. Imaging 480 allows the transaction coordination system 200 to display documents associated with the real estate transaction so that they may be viewed using an imaging program such as ACROBAT READER®, manufactured by Adobe Systems Incorporated, San Jose, Calif. 490, 490a.

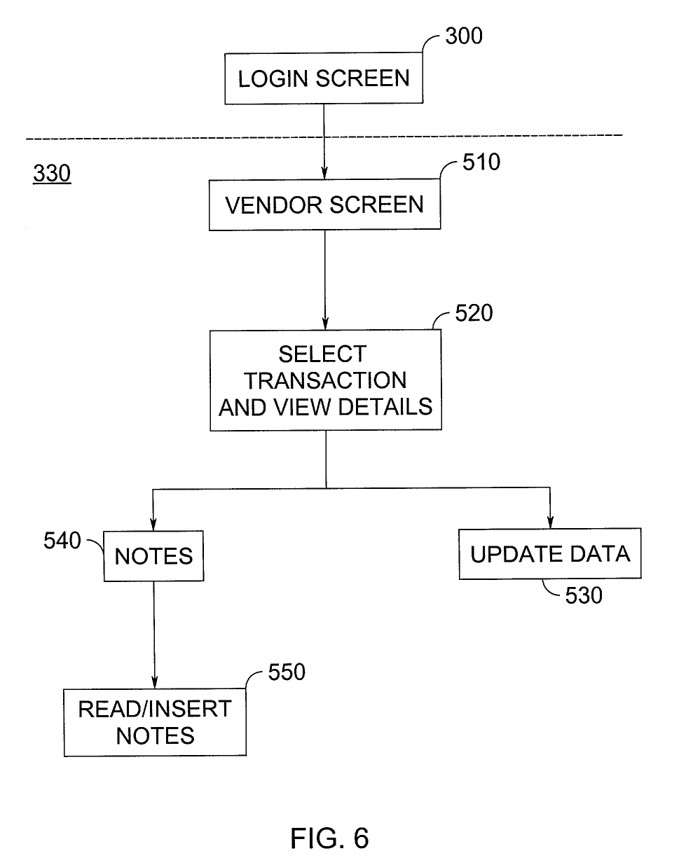

FIG. 6 shows how a vendor can interact with the present invention. After entering the appropriate information at the login screen 300, the user would be identified as a vendor and be sent to an appropriate vendor screen 510. Once at the vendor screen 510, a list of all of the real estate transactions with which the vendor is associated is displayed. If the vendor has any particular messages that are waiting to be read, the vendor is alerted. When the vendor views the real estate transaction details 520, the vendor may find general information about a particular real estate transaction, read and insert notes 550 relating to a particular real estate transaction, and update data 530. In one preferred embodiment, the vendor is given access by the system administrator to update data. This is a significant feature of the present invention. If the vendor enters information directly and in real time, the information is immediately accessible to the other parties. Further, because it is entered directly by the vendor, it is not subject to errors associated with multiple repetitions of information. For example, if the vendor completes an inspection and enters the information directly, the buyer would know that it was complete as soon as it was entered and what problems needed to be fixed. The buyer would not have to make multiple calls to the real estate agent to find out whether the inspection was complete. The buyer would not have to listen as the real estate agent read a list of problems or wait for a faxed or mailed copy of the report. And most likely the report would be more accurate because it would not have to be entered by a person not associated with the inspection.

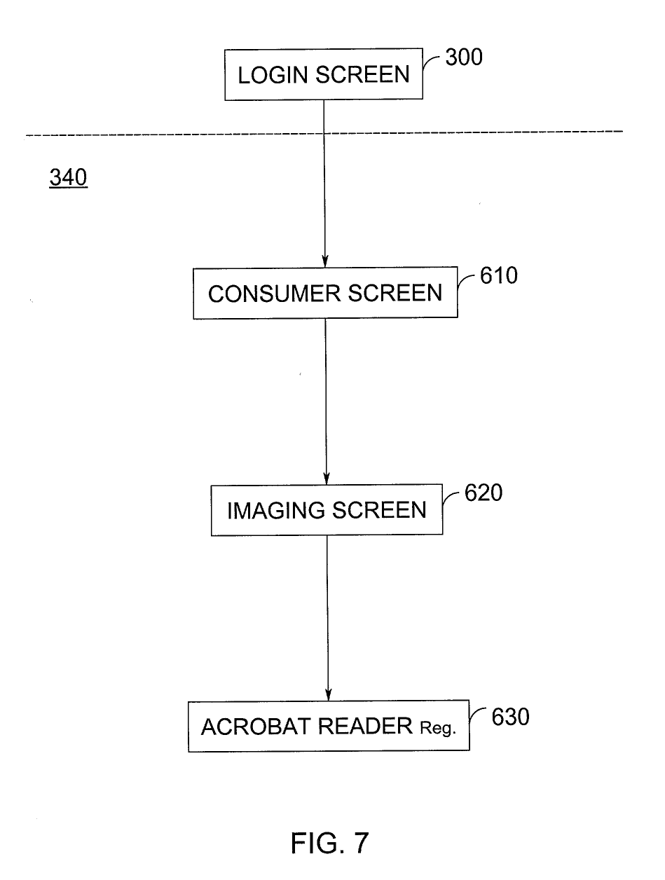

FIG. 7 shows how a consumer can interact with the transaction coordination system 200. After entering the appropriate information at the login screen 300, the user would be identified as a consumer and be sent to an appropriate consumer screen 610. Preferably the consumer's specific details are accessible from the consumer screen 610. Specifically, in one exemplary embodiment the consumer may view a report showing details about his real estate transaction(s), including dates, parties, and property details. Participating vendors and their phone numbers may also be accessed by the consumer. In alternate preferred embodiments the consumer has access to his specific billing information, status reports, and documents. The consumer may further view an imaging screen 620 in which a list of documents capable of being viewed is displayed and then select and view the specific documents using imaging software 630. In still other alternative embodiments, the consumer may take notes, read or insert notes, send and receive messages and email, and otherwise communicate with the other parties of the real estate transaction.

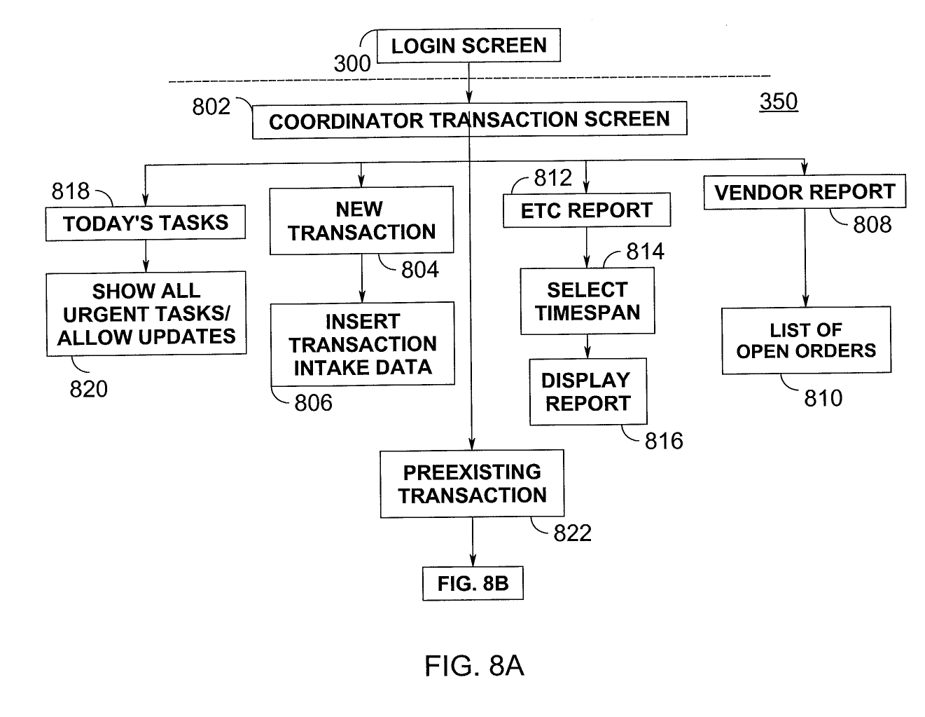

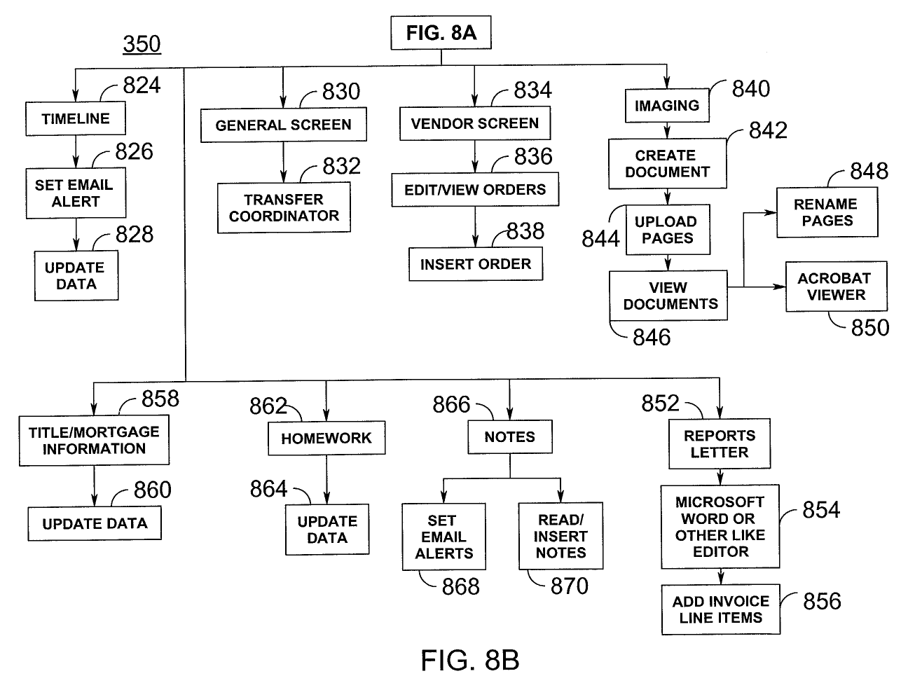

FIGS. 8A-8B show how a transaction coordinator 100 can interact with the transaction coordination system 200. After entering the appropriate information at the login screen 300, the user would be identified as a transaction coordinator and be sent to an appropriate transaction coordinator screen 802. After entering the coordinator screen 802, the transaction coordinator 100 is presented with a variety of features. The coordinator screen 802 preferably displays a list of real estate transactions which may be organized by status, agent, broker, pertinent dates, or otherwise filtered. If any notes relating to a real estate transaction have been left unread, an icon on the coordinator screen 802 is presented. If the transaction coordinator would like to go directly to the unread notes, the transaction coordinator may double click on the icon, which links the transaction coordinator with the notes screen. The link is provided to the transaction coordinator 100 so that he has easy access to the unread notes. Additionally, in one preferred embodiment, from the coordinator screen, the transaction coordinator 100 may select and access each real estate agent's account balances.

The following features set forth in the transaction coordinator screen 802 are meant to be exemplary. Additional features may be added and some of these features specifically mentioned may be modified or deleted. The features may be organized in many alternative formats or may be customizable by the transaction coordinator 100.

A new real estate transaction screen 804 is provided, which allows the transaction coordinator 100 to insert real estate transaction intake data 806. Data entry fields provide the transaction coordinator 100 with the ability to describe the new real estate transaction. If a real estate agent or real estate broker previously entered an online intake order form and forwarded it to the transaction coordinator 100, the transaction coordinator 100 only needs to autofill the data previously entered. The transaction coordinator 100 may further populate combination boxes with data that can be customized to each individual transaction coordinator 100.

A vendor report screen 808 displays a viewable list of open vendors 810 for the transaction coordinator 100 to view. The vendor report screen 808 also provides a link to the vendor screen 510 associated with each known vendor.

A transaction coordinator screen 812 provides the transaction coordinator 100 with the ability to display reports 816. In one preferred embodiment, the transaction coordinator 100 may display certain reports based on selected timespans 814. Other types of reports may also be generated based on dates of transactions, names of consumers, property details, names of persons representing the seller and/or buyer, names of escrow companies and/or escrow agents, names of real estate brokers, names of real estate agents, current status of transaction (active/closed/cancelled), and the date the real estate transaction was opened and/or closed.

The today's task screen 818 displays all urgent timeline items and allows the transaction coordinator 100 to update any of a selected day's tasks 820. In effect, this may function similar to a calendaring program. The today's task screen 818 may be accessible or partially accessible by other parties both for purposes of scheduling events and for finding out upcoming due dates. This screen is a subset of the timeline screen 824 and displays timeline items that need to be displayed in the immediate temporal vicinity of now.

The preexisting real estate transaction screen 822 is a query database for all details of a real estate transaction and items stored in the transaction database 210a-b. The preexisting screen 822 provides the transaction coordinator 100 with super fast retrieval and screen generation regarding all details of a real estate transaction and stored items in the transaction database 210a-b. Using the preexisting screen 822 the transaction coordinator 100 may perform a variety of tasks associated with preexisting real estate transactions.

A general screen 830 allows the transaction coordinator 100 to transfer a specific real estate transaction to a different system coordinator 832. When a system coordinator transfers a specific real estate transaction, the system coordinator gives up responsibility and will not be provided with further access to that specific real estate transaction. The general screen 830 also allows the transaction coordinator 100 to update data, including but not limited to, details about the real estate property, the buyer, the seller, the real estate agent, the real estate broker, and commissions.

A vendor screen 834 allows the transaction coordinator 100 to insert orders 838 based on the type of vendors that have been entered for a particular transaction coordinator 100 by the system administrator. The transaction coordinator 100 may also update, view, and edit details of a previously created order 836. A vendor screen 834 allows the transaction coordinator 100 to place orders 838 or otherwise contact vendors to request services. The transaction coordinator 100 may be given the option of all vendors in the transaction database 210a-b, a grouping of vendors based on specialties, or a shortened list determined by the system administrator. The transaction coordinator 100 may also update, view, confirm and edit details of a previously created order 836.

A title/mortgage information screen 858 allows the transaction coordinator 100 to update and view details 860 regarding particular real estate transactions. The title mortgage screen allows the transaction coordinator 100 to also confirm and edit details of a particular real estate transaction 860.

A homework screen 862 allows the transaction coordinator 100 to view and update details 864 based on a details setup by the transaction coordinator 100 or system administrator. The homework screen 862 provides the transaction coordinator 100 with a homework form that presents administrative and safety questions relating to a particular real estate transaction. The homework screen 862 may further provide appropriate contact information for the transaction coordinator 100 so that the questions relating to a particular real estate transaction may be answered. As answer to questions relating to a particular real estate transaction are provided to the transaction coordinator 100, the homework screen may provide input areas for the data to be entered and updated 864. When the homework screen 862 is completed, the homework may be wiped off the timeline 824 and reports may be generated from the updated information 864.

A timeline screen 824 allows the transaction coordinator 100 to access and, if appropriate, update 828 details based on the chronology of the real estate transaction. For example, depending on the relevant laws, certain projects may need to be completed in a certain order and at certain times. The transaction coordinator 100 would be able to monitor the specific transaction to verify that relevant deadlines are being met. The timeline screen 824 also provides the transaction coordinator 100 with the ability to set e-mail alerts to alert e-mail 826 or mobile device systems about a task that needs to be done.

An imaging screen 840 allows the transaction coordinator 100 to create a document 842, upload pages to document 844, manipulate an uploaded file and save to imaging server in an imaging format such as TIFF and Adobe PDF. In a preferred embodiment, documents that have been sent to the transaction coordinator 100 via facsimile, may be uploaded. From this screen the transaction coordinator 100 can also view documents 846 with imaging software 850, and rename and reorder pages 848.

A reports and letters screen 852, allows the transaction coordinator 100 to modify or add a real estate transaction invoice item 856. The transaction coordinator 100 may generate reports and letters based on a custom setup by the system administrator. The reports and letters screen 852 further allows the reports and letters to be displayed in Microsoft (MS) Word or other similar editor. From the reports and letters screen 852 the transaction coordinator can develop marketing materials such as creating listing books, marketing flyers, and other written material. The reports and letters screen 852 allows the transaction coordinator to maintain post-transaction relationships with clients or other parties. For example, the transaction coordinator 100 can send appropriate greetings for holidays, birthdays, and anniversaries or send information on changes in the law, or properties in which the client might be interested. The transaction coordinator 100 can also create appropriate custom correspondence between any and all parties to a particular real estate transaction. In one preferred embodiment, the transaction coordinator 100 receives correspondence and merges that correspondence into the system, thereby creating a correspondence document that can be mailed, emailed, or sent via facsimile to the client.

The notes screen 866 allows the transaction coordinator 100 to switch between different real estate transaction notes screens. The notes screen 866 also provides for quick inputting of notes 870 about specific real estate transactions without the transaction coordinator 100 having a lengthy diversion from their current task.

Further, the notes screen 866 allows the transaction coordinator 100 to set and delete e-mail alerts 868 to notify Internet e-mail or mobile devices, including but not limited to, PDA's, pagers, or mobile phones, of tasks that need to be completed.

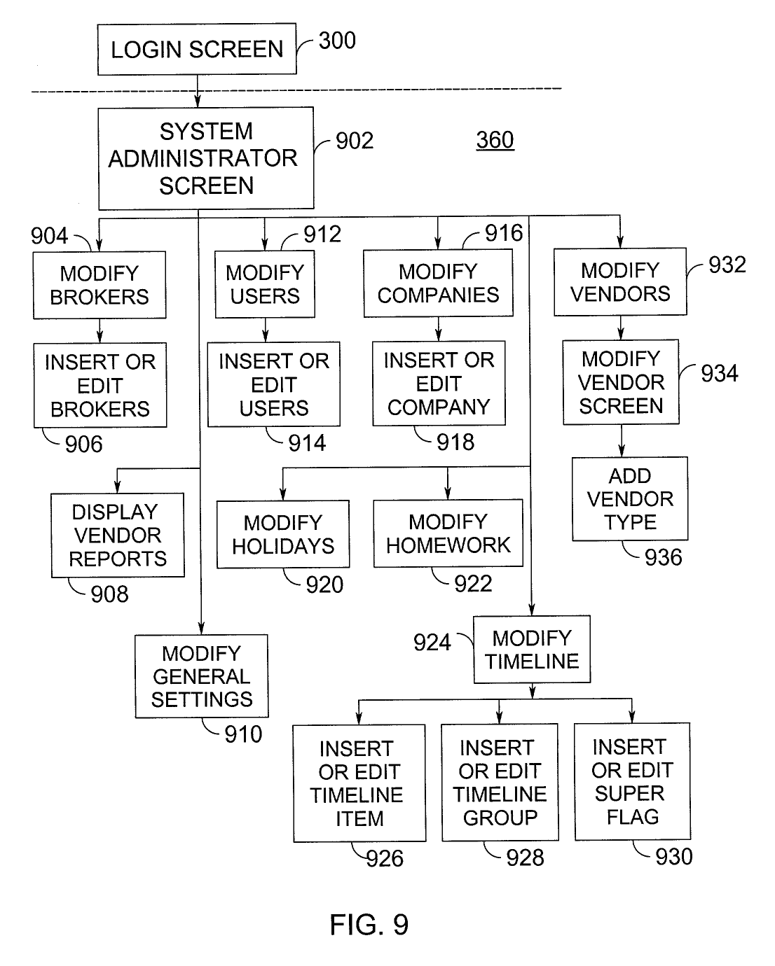

FIG. 9 shows how a system administrator can interact with the transaction coordination system 200. After entering the appropriate information at the login screen 300, the user would be identified as a system administrator and be sent to an appropriate system administrator screen 902. From the administrator screen 902 the system administrator may perform a variety of addition, modification, and deletion functions that result in changes in the entire transaction coordination system 200.

The system administrator is capable of displaying a list of users that the current system administrator controls. The system administrator is then able to modify the users 912, insert and edit users 914, and delete users. In one preferred embodiment safeguards are in place so that prior to modifying, inserting, or deleting users the system administrator notifies the appropriate party and verifies the change.

For purpose of modifying users, each user in the transaction coordination system 200 of the present invention must be given both a user type and a company. Therefore, one must create the associated company before creating the user if one is doing it at the same time.

A real estate agent must be given a unique agent number so that the real estate agent can be associated with his real estate transactions. The unique agent number allows the agent screen to display all agent real estate transactions.

The system administrator may also modify brokers 904 within the transaction database 210a-b. The system administrator may display a list of brokers that the current system administrator has control over and allow insertions and edits relating to the brokers 906.

The system administrator may also modify the companies 916 within the transaction database 210a-b. The system administrator may display a list of companies that the current system administrator has control over and allow insertions and edits relating to the companies 918. The company must be given a user type before being able to be edited by the system administrator.

The system administrator may also modify holidays 920 within the transaction coordination system 200. The system administrator may both insert and edit holidays so that the transaction coordinator 100 will be aware when setting timelines to close a particular real estate transaction on dates when people, located in specific geographical locations having varying holidays, might not be working.

The system administrator may modify vendors 932 within the transaction database 210a-b. Vendor types may be added 936, and the vendor screen may be modified 934. The system administrator may further create an order form layout based on the vendor's own order form so that the vendor is using a form that they are both familiar with and comfortable with. The system administrator may further associate fields with timeline items such that when the fields are completed, the appropriate transaction coordinator 100 timeline item is completed and the field detail is filled in to the appropriate timeline item.

The system administrator may modify homework 922. The system administrator may create a property homework form for the transaction coordinator 100, which may include instructions as how to handle each telephone call, a phone number, names, and any further details necessary to perform the homework. The system administrator may also list each month's orders by vendor type and vendor. The administrator screen 902 may also allow provide the number of orders and some detail. This is designed for the system administrator to generate billing if the vendor is charged for the business it receives from the parties.

The system administrator may modify the timeline 924. The system administrator may insert or edit superflags. Each superflag is a warning device that is given a timeline item, a number and a message. The number is the number of days before a timeline item comes due to notify the transaction coordinator 100 of important events in each real estate transaction. The system administrator may further insert or edit a timeline group 928. Timeline items are based on due dates set to correspond with a specific date in time after the transaction has started or closed. Timeline items are organized in groups and displayed in a certain order based on their group. Each timeline group is given a name and an order of appearance on the timeline screen for the transaction coordinator 100. The system administrator may insert or edit a timeline item 926. Timeline items are given several details that distinguish and add to their usefulness. Included in this list are several options that describe the types of real estate transaction this item will be active for. The item will only be active if all criteria are true at anytime during the life of each real estate transaction.

The system administrator may also modify the general settings 910. This allows for the modification of the most general settings for each coordination group. These settings include the defaults they use as well as the labels on several fields and instructions on the online intake. It also allows the system administrator to turn on and off many of the modules in the transaction coordination system 200. These modules include homework, billing, imaging, faxing, online intake, etc.

The transaction coordination system 200 can be programmed to take into account the neighborhood-to-neighborhood, region-to-region, state-to-state, and country-to-country variations in procedures that may dictate how a real estate transaction is carried out. Further, the transaction coordination system 200 may be physically divided or all located in a single location. Additionally, the transaction coordination system can be copied from one transaction coordination system to another transaction coordination system.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A system for coordinating the flow of data relating to at least one real estate transaction between parties associated with said real estate transaction, said system comprising:
(a) a centralized transaction coordination system for accessing a transaction database;
(b) at least one interface device for accessing said transaction coordination system, each interface device associated with a party to said real estate transaction;
(c) information relevant to said real estate transaction being provided directly to said transaction coordination system by at least one information originating party originating said information;
(d) said information being stored in said transaction database; and
(e) said information being accessible by at least one party to said real estate transaction using said at least one interface device to access said transaction coordination system.

2. The system of claim 1 wherein said centralized coordination system is a distributed computing network.

3. The system of claim 1 wherein said at least one interface device is selected from a group consisting of:
(a) a computer;
(b) a laptop computer;
(c) a PDA; and
(d) any type of networkable interface device.

4. The system of claim 1 wherein said information originating party is selected from a group consisting of:
(a) a transaction coordinator;
(b) a system administrator;
(c) a consumer;
(d) a buyer;
(e) a seller;
(f) a real estate agent;
(g) a real estate broker;
(h) a vendor;
(i) an escrow company;
(j) a title company;
(k) a lending institution;
(l) an escrow agent;
(m) a warranty provider;
(n) an appraiser;
(o) an inspector;
(p) an insurance company;
(q) an appraisers;
(r) a utility provider;
(s) a survey company;
(t) a government entity;
(u) a builder;
(v) an engineer;
(w) a material provider;
(x) an attorney;
(y) any service provider; and
(z) an agent and or staff member of (a)-(y).

5. The system of claim 1 wherein said at least one party to said real estate transaction is selected from a group consisting of:
(a) a transaction coordinator;
(b) a system administrator;
(c) a consumer;
(d) a buyer;
(e) a seller;
(f) a real estate agent;
(g) a real estate broker;
(h) a vendor;
(i) an escrow company;
(j) a title company;
(k) a lending institution;
(l) an escrow agent;
(m) a warranty provider;
(n) an appraiser;
(o) an inspector;
(p) an insurance company;
(q) an appraisers;
(r) a utility provider;
(s) a survey company;
(t) a government entity;
(u) a builder;
(v) an engineer;
(w) a material provider;
(x) an attorney;
(y) any service provider; and
(z) an agent and or staff member of (a)-(y).

6. The system of claim 1 further comprising a transaction coordinator for monitoring said information relevant to said real estate transaction.

7. The system of claim 6 wherein said at least one real estate transaction is a plurality of real estate transactions, said transaction coordinator for monitoring said information relevant to said plurality of real estate transactions.

8. The system of claim 1 further comprising a login screen through which said at least one party to said real estate transaction accesses said transaction coordination system.

9. The system of claim 1 further comprising a customized screen associated with said at least one party to said real estate transaction through which access to said transaction coordination system is provided.

10. The system of claim 1 wherein said at least one party to said real estate transaction enters login information at a login screen, said login information determining an access screen through which access to said transaction coordination system is provided, said access screen selected from a group consisting of:
(a) a transaction coordinator screen;
(b) a system administrator screen;
(c) a consumer screen;
(d) a buyer screen;
(e) a seller screen;
(f) a real estate agent screen;
(g) a real estate broker screen;
(h) a vendor screen;
(i) an escrow company screen;
(j) a title company screen;
(k) a lending institution screen;
(l) an escrow agent screen;
(m) a warranty provider screen;
(n) an appraiser screen;
(o) an inspector screen;
(p) an insurance company screen;
(q) an appraisers screen;
(r) a utility provider screen;
(s) a survey company screen;
(t) a government entity screen;
(u) a builder screen;
(v) an engineer screen;
(w) a material provider screen;
(x) an attorney screen;
(y) a service provider screen; and
(z) a customized screen.

11. The system of claim 1 further comprising a login screen through which said at least one party to said real estate transaction accesses said transaction coordination system, said at least one type of information to which said at least one party to said real estate transaction has access selected from the group consisting of:
(a) general information pertaining to said real estate transaction;
(b) information associated with a particular real estate property;
(c) scheduling information;
(d) a timeline of events associated with said real estate transaction;
(e) status reports associated with said real estate transaction;
(f) notes associated with said real estate transaction;
(g) information pertaining to other parties associated with said real estate transaction;
(h) communication links to other parties associated with said real estate transaction;
(i) billing information;
(j) viewable documents;
(k) homework information;
(l) online order information;
(m) data entry; and
(n) information associated with other parties' productivity.

12. A method for coordinating the flow of data relating to at least one real estate transaction between parties associated with said real estate transaction, said method comprising:
(a) networking a transaction database to form a centralized transaction coordination system;
(b) allowing access to said transaction coordination system through at least one interface device, each interface device being associated with a party to said real estate transaction;
(c) providing information relevant to said real estate transaction directly to said transaction coordination system by at least one information originating party originating said information;
(d) storing said information in said transaction database; and
(e) allowing access to said information to at least one party to said real estate transaction using said at least one interface device to access said transaction coordination system.

13. The method of claim 12 further comprising the step of monitoring said information relevant to said real estate transaction using a transaction coordinator.

14. The method of claim 13 further comprising the step of monitoring a plurality of real estate transactions using said transaction coordinator.

15. The method of claim 12 further comprising the step of creating access levels.

16. The method of claim 15 further comprising the step of assigning access levels to each at least one party to said real estate transaction.

17. A system for coordinating the flow of data relating to at least one real estate transaction between parties associated with said real estate transaction, said system comprising:
(a) a centralized transaction coordination system for accessing a transaction database;
(b) at least one interface device for accessing said transaction coordination system, each interface device associated with a party to said real estate transaction;
(c) a login screen through which each party to said real estate transaction system accesses said transaction coordination system by entering login information;
(d) a plurality of access levels;
(e) each party to said real estate transaction having an associated access level determinable by said login information;
(f) a plurality of access screens;
(g) each party to said real estate transaction accessing said transaction coordination screen through an associated access screen, said access screen determinable by said access level; and
(h) information relevant to said real estate transaction being provided directly to said transaction coordination system by at least one information originating party originating said information.

18. The system of claim 17 wherein said information originating party is selected from a group consisting of:
(a) a transaction coordinator;
(b) a system administrator;
(c) a consumer;
(d) a buyer;
(e) a seller;
(f) a real estate agent;
(g) a real estate broker;
(h) a vendor;
(i) an escrow company;
(j) a title company;
(k) a lending institution;
(l) an escrow agent;
(m) a warranty provider;
(n) an appraiser;
(o) an inspector;
(p) an insurance company;
(q) an appraisers;
(r) a utility provider;
(s) a survey company;
(t) a government entity;
(u) a builder;
(v) an engineer;
(w) a material provider;
(x) an attorney;
(y) any service provider; and
(z) an agent and or staff member of (a)-(y).

19. The system of claim 17 wherein said at least one party to said real estate transaction is selected from a group consisting of:
(a) a transaction coordinator;
(b) a system administrator;
(c) a consumer;
(d) a buyer;
(e) a seller;
(f) a real estate agent;
(g) a real estate broker;
(h) a vendor;
(i) an escrow company;
(j) a title company;
(k) a lending institution;
(l) an escrow agent;
(m) a warranty provider;
(n) an appraiser;
(o) an inspector;
(p) an insurance company;
(q) an appraisers;
(r) a utility provider;
(s) a survey company;
(t) a government entity;
(u) a builder;
(v) an engineer;
(w) a material provider;
(x) an attorney;
(y) any service provider; and
(z) an agent and or staff member of (a)-(y).

20. The system of claim 17 further comprising a transaction coordinator for monitoring said information relevant to said real estate transaction.

21. The system of claim 20 wherein said at least one real estate transaction is a plurality of real estate transactions, said transaction coordinator for monitoring said information relevant to said plurality of real estate transactions.

22. The system of claim 17 each party to said real estate transaction having an associated customized access level determinable by said login information.

23. The system of claim 17 each party to said real estate transaction having an associated customized access level determinable by said login information and an associated customized access screen determinable by said customized access level, each party to said real estate transaction being provided access only to information associated with real estate transactions to which said party is associated.
